(19) United States
(12) Patent Application Publication
(10) Pub. No.: US 2025/0229236 A1
(43) Pub. Date: Jul. 17, 2025

(54) Air Extraction and Wine Extraction Two-In-One Extraction Device

(71) Applicant: KITCHENDAO KITCHENWARE CO., LTD, Yangjiang (CN)

(72) Inventors: Jiajie ZHONG, Yangjiang (CN); Haisheng CHEN, Yangjiang (CN); Jing HUANG, Yangjiang (CN)

(21) Appl. No.: 19/030,239

(22) Filed: Jan. 17, 2025

(30) Foreign Application Priority Data
Jan. 17, 2024 (CN) 202420122645.1

(51) Int. Cl. B01F 23/2361; B01F 33/501; B01F 35/222; B01F 101/17

(52) U.S. Cl. CPC B01F 23/2361; B01F 33/5011; B01F 35/222; B01F 2101/17

(57) ABSTRACT

The present disclosure relates to an air extraction and wine extraction two-in-one extraction device, including a housing, a wine extraction mechanism, an air extraction mechanism, an extraction switch, a switching mechanism, a wine plug and a controller. The wine extraction mechanism, the air extraction mechanism and the controller are all arranged in the housing. The extraction switch is also arranged on the housing and partially exposed from the housing. The switching mechanism is detachably arranged at a bottom of the housing. An extraction channel is arranged in the housing. The wine plug is located at a bottom of the switching mechanism. The wine extraction mechanism, the air extraction mechanism and the wine plug are all in communication with the extraction channel. The wine extraction mechanism, the air extraction mechanism, the switching mechanism and the extraction switch are all electrically connected with the controller.

### CROSS-REFERENCE TO RELATED APPLICATION

This application claims priority to Chinese Patent Application No. CN202420122645.1, filed to the China National intellectual Property Administration on Jan. 17, 2024 and entitled “Air Extraction and Wine Extraction Two-In-One Extraction Device”, the disclosure of which is hereby incorporated by reference in its entirety.

### TECHNICAL FIELD

The present disclosure relates to the technical field of a red wine extraction device, and more specifically, to an air extraction and wine extraction two-in-one extraction device.

### BACKGROUND

In order to facilitate the pouring of red wine, a wine extraction device is usually mounted at an opening of a wine bottle, and the red wine in the wine bottle can be easily extracted out by the wine extraction device. When the red wine is not drunk completely once after being opened, the air in the wine bottle needs to be extracted out to form a vacuum environment inside the wine bottle to extend the shelf life of the red wine, so that the red wine can maintain good taste and quality during the storage process. In order to meet the two needs of users simultaneously, the wine extraction device needs to be combined with a vacuumizing device. At present, there are two types of products combining wine extraction and sealing on the market: One type is an integrated product; the product is directly inserted into a wine bottle; the modes are selected and switched through a button, or the product directly enters a vacuumizing mode after the red wine is extracted; the product must be remained at a bottle opening during sealed storage; and due to a larger volume, the product may cause the red wine to occupy a larger space during the storage process, resulting in inconvenience to users. The other type is: the product is additionally provided with a wine plug; however, the wine plug is externally arranged separately during the vacuumizing process; the wine plug and the product are in a separated state during the vacuumizing process; after the wine bottle is vacuumized, the wine plug is removed and directly inserted into the wine bottle for sealing; and the product may cause the air to enter the wine bottle again during the process of switching between a vacuumized component and the wine plug, so that the vacuum state of the wine bottle cannot be achieved truly, which is not conducive to the sealed storage of the red wine.

### SUMMARY

In order to overcome the problem that an extraction device with both wine extraction and vacuumizing functions cannot be removed after a wine bottle is vacuumed, which causes the occupation of excessive storage space, or the problem that a wine plug is mounted at a bottle opening after vacuumizing by the extraction device, which affects the sealing effect during the component switching process, the present disclosure provides an air extraction and wine extraction two-in-one extraction device, which can overcome the above two problems, and can not only prevent excessive storage space from being additionally occupied during the storage process of red wine, but also provide better sealing and preservation effects for red wine.

In order to achieve the above objectives, the present disclosure adopts the following technical solutions:

Provided is an air extraction and wine extraction two-in-one extraction device, including a housing, a wine extraction mechanism, an air extraction mechanism, an extraction switch, a switching mechanism, a wine plug and a controller. The wine extraction mechanism, the air extraction mechanism and the controller are all arranged in the housing. The extraction switch is also arranged on the housing and partially exposed from the housing. The switching mechanism is detachably arranged at a bottom of the housing. An extraction channel is arranged in the housing. The wine plug is arranged at a bottom of the switching mechanism. The wine extraction mechanism, the air extraction mechanism and the wine plug are all in communication with the extraction channel. The wine extraction mechanism, the air extraction mechanism, the switching mechanism and the extraction switch are all electrically connected with the controller. When the switching mechanism and the wine plug are not mounted, the extraction device is in a wine extraction mode by default. When the switching mechanism and the wine plug are mounted, the extraction device is switched to an air extraction mode.

The extraction device of the present disclosure is an electric product with a combination of wine extraction and wine bottle vacuumizing functions. The switching mechanism is used as a switch for switching two modes to achieve function conversion. When the switching mechanism and the wine plug are removed, the product is in the wine extraction mode by default, and the extraction switch is pressed to enable the wine extraction mechanism to operate, and then, the red wine is extracted out. When the switching mechanism and the wine plug are mounted, the product is switched to the air extraction mode, a consumer first inserts the wine plug into an opening of the wine bottle, then aligns the switching mechanism with an interface of the wine plug, and presses the extraction switch to enable the air extraction mechanism to operate, and thus, the air in the wine bottle is extracted out to reach a vacuum state in the bottle to achieve sealing; and after the air extraction is completed, the housing is removed, and the wine plug is retained on the wine bottle for sealing. The inventive point of the present disclosure lies in the structure that achieves a combination of wine extraction and vacuumizing functions by disassembling and changing parts. Within the cognitive scope of those skilled in the art, the extraction device of the present disclosure can be applied to extraction and sealing of red wine, and can also be applied to extraction of other alcoholic or non-alcoholic bottled liquids and vacuumizing inside bottles.

Further, the wine extraction mechanism includes a wine extraction pump, a wine nozzle and a wine extraction pipe. One end of the wine nozzle is connected with the housing, and the other end of the wine nozzle protrudes from the housing. The wine extraction pump is arranged in the housing. The wine extraction pipe is detachably connected with the bottom of the housing. The wine extraction pump, the wine extraction pipe and the wine nozzle are all in communication with the extraction channel. In the wine extraction mode, the consumer inserts the wine extraction pipe, inserts the housing into the wine bottle and presses the extraction switch, the wine extraction pump operates, and the red wine in the wine bottle is extracted out through the wine nozzle via the wine extraction pipe. The wine extraction pipe is detachably connected with the bottom of the housing to facilitate the separation of the wine extraction pipe from the housing, so that when the wine extraction mode is switched to the air extraction mode, a vacuumizing function of the wine bottle can be achieved.

Further, an end of the wine nozzle away from the housing is obliquely arranged downwards. By this arrangement, the red wine can be poured out from the wine nozzle conveniently.

Further, the wine extraction pipe is a retractable structure. The wine extraction pipe having the retractable structure can expand the scope of application of the extraction device of the present disclosure. Especially, for wine bottles of different depths, the length of the wine extraction pipe can be adaptively adjusted to achieve the wine extraction function. Within the cognitive scope of those skilled in the art, the wine extraction pipe can also be a conventional non-retractable structure. Preferably, the wine extraction pipe is made of a silicone material.

Further, the air extraction mechanism is an air extraction pump. The air extraction pump is configured to extract the air from the wine bottle to ensure a vacuum state inside the wine bottle, thereby facilitating the sealed storage of red wine.

Further, the switching mechanism includes a support frame, a passive trigger part and an active trigger part. The passive trigger part is arranged at the bottom of the housing and is electrically connected with the controller. The active trigger part is arranged on the support frame. One end of the support frame is detachably connected with the housing, and the other end of the support frame is detachably connected with the wine plug. When the support frame is connected with the housing, the active trigger part can trigger the passive trigger part to send a signal. The support frame is configured to mount the active trigger part, and enables the switching mechanism to be detachably connected with the housing or the wine plug conveniently. The active trigger part performs active triggering to enable the passive trigger part to receive a triggering signal so as to transmit the signal to the controller, so that the controller achieves the switching between the wine extraction mode and the air extraction mode.

Further, the active trigger part is a magnet, and the passive trigger part is a Hall sensor; or the active trigger part is a convex pillar, and the passive trigger part is a trigger switch; or the active trigger part is a pin, and the passive trigger part is a conductive pin. The magnet can touch the Hall sensor and trigger the Hall sensor to send a signal to the controller to perform switching between modes. Similarly, the active trigger part can be other structures for triggering, and the passive trigger part can be structures that can send a signal after being triggered by the active trigger part. There can be various triggering principles, including but not limited to the methods listed above.

Further, the wine plug includes a plug sleeve and a plug body. An air duct is arranged in the plug sleeve, and the plug sleeve is detachably connected with the bottom of the switching mechanism. The plug body is movably arranged in the plug sleeve and can open the air duct to communicate the air duct with the extraction channel or close the air duct. When the switching mechanism is in contact with the wine plug and is in an air extraction mode, the wine plug can be opened. When the switching mechanism is moved away from the wine plug, the wine plug can be closed automatically. The inside of the plug sleeve cooperates with the plug body, so that the opening or closing of the air duct can be controlled according to different positions of the plug body in the plug sleeve. The outside of the plug sleeve is configured to cooperate with the wine bottle to achieve the sealing between an outer wall of the plug sleeve and an inner wall of an opening of the wine bottle.

Further, a circumferential outer wall of the plug sleeve is provided with a plurality of protrusions. By the arrangement of the protrusions, the friction force between the plug sleeve and the bottle opening of the wine bottle can be increased, and the sealing effect of the wine plug can be improved.

Further, the wine extraction pump is a suction pump or an air injection pump. When the wine extraction pump adopts the suction pump, the red wine in the wine bottle can be extracted out through the principle of suction. When the wine extraction pump adopts the air injection pump, the red wine can be pressed into the wine extraction pipe by injecting air into the wine bottle, and then flows out from the wine nozzle.

The present disclosure has the following beneficial effects:
(1) The extraction device of the present disclosure has a wine extraction function and a wine bottle vacuumizing function simultaneously. Moreover, after the air extraction is completed, the main body part of the extraction device can be removed, and only the wine plug is retained on the wine bottle for sealing, thereby greatly saving the storage space of wine.
(2) The switching mechanism can be configured to cooperate with the controller to achieve the switching between the wine extraction mode and the air extraction mode. In the wine extraction mode, the switching mechanism does not need to be mounted. In the air extraction mode, the switching mechanism and the wine plug need to be mounted. The switching between the two modes is very convenient. Moreover, during the air extraction process, the wine plug is always retained at the opening of the wine bottle. During the air extraction process, the air duct in the wine plug is opened. After the air extraction is completed, the air duct in the wine plug is closed. During the entire process, the inside of the wine bottle is always maintained in a vacuum state, and the sealing effect is good.
(3) The switching mechanism triggers a signal when the active trigger part is in contact with the passive trigger part, and then transmits a mode switching signal to the controller. There can be various structures and triggering principles of the active trigger part and the passive trigger part, including but not limited to a form of using a sensor or a mechanical button for implementation.

### BRIEF DESCRIPTION OF THE DRAWINGS

FIG. 1 is an exploded structural diagram of an air extraction and wine extraction two-in-one extraction device of the present disclosure.

FIG. 2 is a structural diagram of an air extraction and wine extraction two-in-one extraction device of the present disclosure in a wine extraction mode without a wine extraction pipe.

FIG. 3 is a structural diagram of an air extraction and wine extraction two-in-one extraction device of the present disclosure in an air extraction mode without a wine plug.

FIG. 4 is a structural diagram of an air extraction and wine extraction two-in-one extraction device of the present disclosure in an air extraction mode in another direction.

FIG. 5 is a cross-sectional exploded structural diagram along A-A in FIG. 4.

FIG. 6 is a cross-sectional diagram of an air extraction and wine extraction two-in-one extraction device of the present disclosure in a wine extraction mode.

FIG. 7 is a use reference diagram of an air extraction and wine extraction two-in-one extraction device of the present disclosure in a wine extraction mode.

FIG. 8 is a use reference diagram of an air extraction and wine extraction two-in-one extraction device of the present disclosure in an air extraction mode.

FIG. 9 is a structural diagram of an air extraction and wine extraction two-in-one extraction device according to Embodiment 1 of the present disclosure after a switching mechanism is disassembled.

FIG. 10 is a structural diagram of an air extraction and wine extraction two-in-one extraction device according to Embodiment 2 of the present disclosure after a switching mechanism is disassembled.

FIG. 11 is a structural diagram of an air extraction and wine extraction two-in-one extraction device according to Embodiment 3 of the present disclosure after a switching mechanism is disassembled.

FIG. 12 is a cross-sectional diagram of an air extraction and wine extraction two-in-one extraction device according to Embodiment 4 of the present disclosure in a wine extraction mode.

FIG. 13 is a use reference diagram of an air extraction and wine extraction two-in-one extraction device according to Embodiment 4 of the present disclosure in a wine extraction mode.

### THE DESCRIPTION OF REFERENCE NUMERALS IS AS FOLLOWS

1. housing; 11. extraction channel; 12. air inlet; 2. wine extraction mechanism; 21. wine extraction pump; 211. wine pump inlet; 212. wine pump outlet; 22. wine nozzle; 23. wine extraction pipe; 3. air extraction mechanism; 4. extraction switch; 5. switching mechanism; 51. support frame; 52. active trigger part; 521. magnet; 522. convex pillar; 523. pin; 53. passive trigger part; 531. Hall sensor; 532. trigger switch; 533. conductive pin; 6. wine plug; 61. plug sleeve; 62. plug body; 63. air duct; 64. protrusion; 7. controller; 8. wine bottle.

### DETAILED DESCRIPTION OF THE EMBODIMENTS

The accompanying drawings are for illustrative purposes only and should not be construed as limiting this patent. In order to better illustrate this embodiment, some components in the accompanying drawings may be omitted, enlarged or reduced, and do not represent the actual dimensions of products. For those skilled in the art, it can be understood that some well-known structures and descriptions thereof in the accompanying drawings may be omitted. The description of the position relationship in the accompanying drawings is for the illustrative purpose only and should not be construed as limiting this patent.

The same or similar reference numerals in the accompanying drawings of the embodiments of the present disclosure correspond to the same or similar components. In the description of the present disclosure, it should be understood that the orientation or position relationships indicated by terms “upper”, “lower”, “left”, “right”, “long”, “short” and the like are based on orientation or position relationships shown in the accompanying drawings, and are intended to facilitate the description of the present disclosure and simplify the description only, rather than indicate or imply that the device or element referred to must have a particular orientation or be constructed and operated in a particular orientation. Therefore, the terms for describing position relationships in the accompanying drawings are for illustrative purposes only and should not be construed as limiting this patent. For those of ordinary skill in the art, the specific meanings of the above terms can be understood according to specific situations.

The technical solutions of the present disclosure are further specifically described below through specific embodiments with reference to the accompanying drawings.

### Embodiment 1

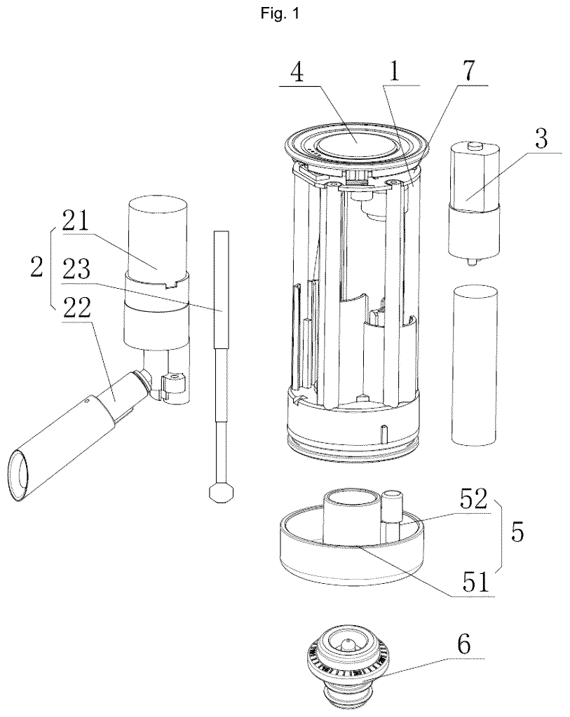

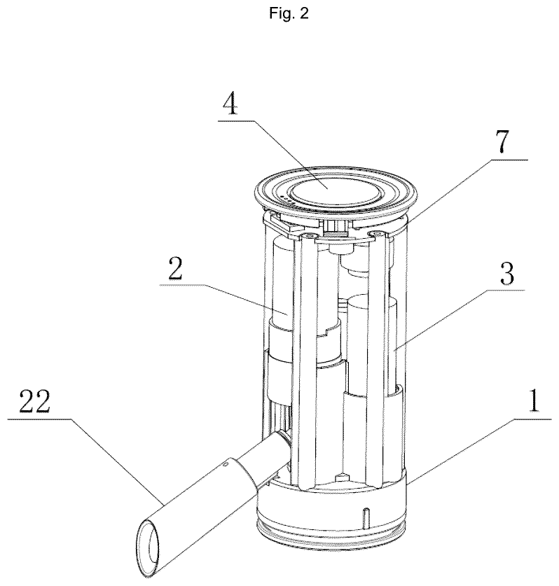

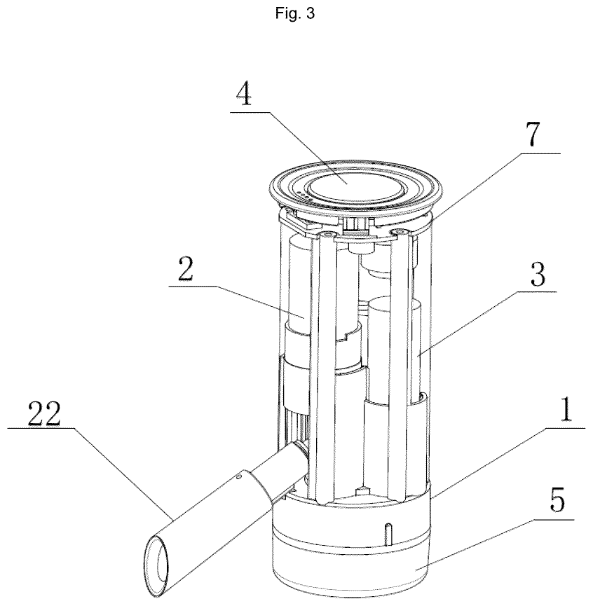

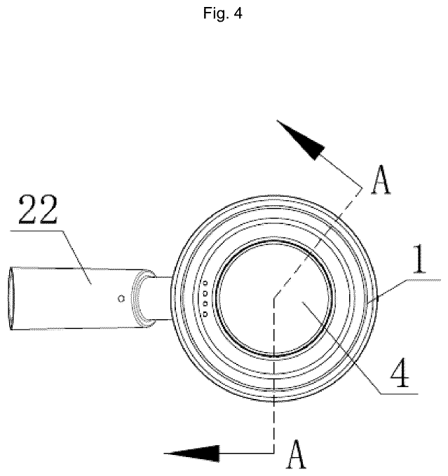

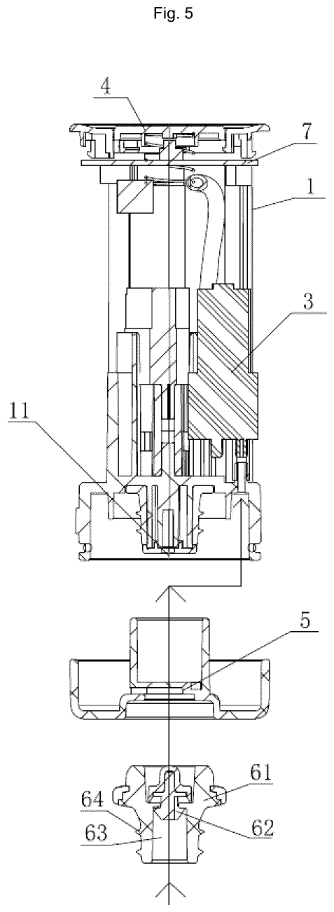

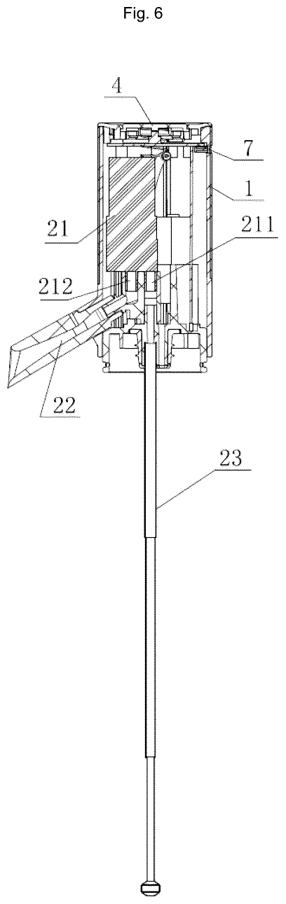

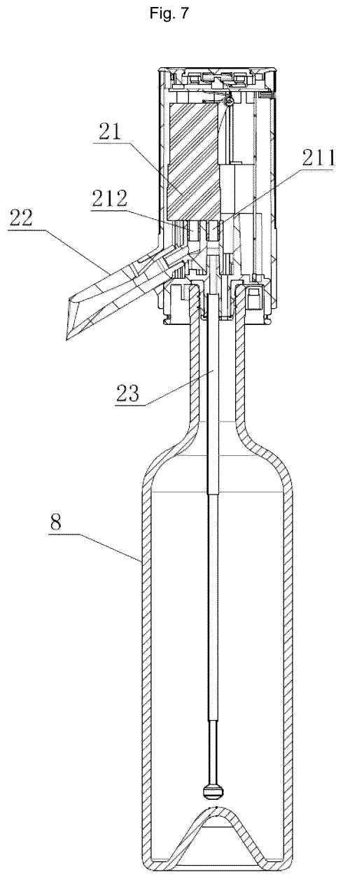

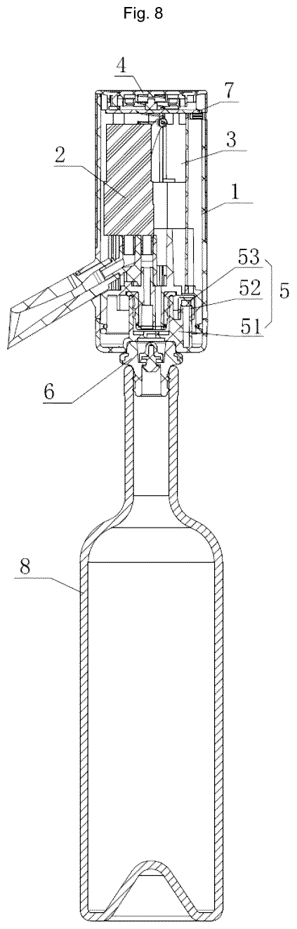

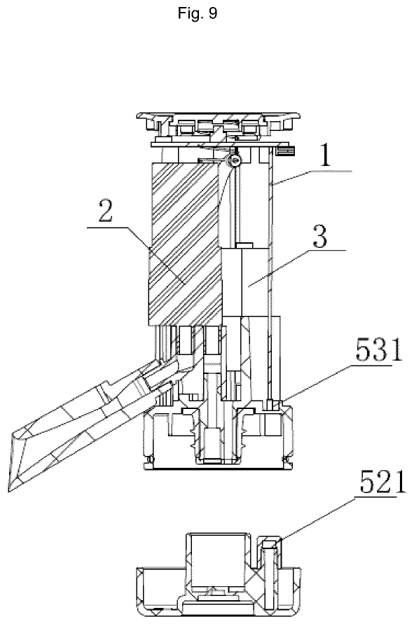

FIG. 1 to FIG. 9 show an air extraction and wine extraction two-in-one extraction device according to Embodiment 1 of the present disclosure, including a housing 1, a wine extraction mechanism 2, an air extraction mechanism 3, an extraction switch 4, a switching mechanism 5, a wine plug 6 and a controller 7. The wine extraction mechanism 2, the air extraction mechanism 3 and the controller 7 are all arranged in the housing 1. The extraction switch 4 is also arranged on the housing 1 and partially exposed from the housing 1. The switching mechanism 5 is detachably arranged at a bottom of the housing 1. An extraction channel 11 is arranged in the housing 1. The wine plug 6 is arranged at a bottom of the switching mechanism 5. The wine extraction mechanism 2, the air extraction mechanism 3 and the wine plug 6 are all in communication with the extraction channel 11. The wine extraction mechanism 2, the air extraction mechanism 3, the switching mechanism 5 and the extraction switch 4 are all electrically connected with the controller 7. When the switching mechanism 5 and the wine plug 6 are not mounted, the extraction device is in a wine extraction mode by default. When the switching mechanism 5 and the wine plug 6 are mounted, the extraction device is switched to an air extraction mode.

The housing 1 is configured to provide a mounting space for the wine extraction mechanism 2 and the air extraction mechanism 3, and various components are integrated in the housing 1. The wine extraction mechanism 2 is configured to extract red wine, so that the red wine can be poured out conveniently. The air extraction mechanism 3 is configured to extract air in the wine bottle 8 to reach a vacuum state in the wine bottle 8, which is beneficial for storing the red wine for a short time when the red wine is not drunk completely once after being opened, so that the red wine can always maintain good taste and quality during the storage process. The extraction switch 4 is configured to control the opening or closing of the wine extraction mechanism 2 or the air extraction mechanism 3. The switching mechanism 5 is used for switching between a wine extraction mode and an air extraction mode. In fact, the switching mechanism 5 can achieve the triggering of a signal, and the controller 7 is configured to control the switching between modes. When the controller 7 receives a switching signal from the switching mechanism 5, the switching between the wine extraction mode and the air extraction mode is performed, and the wine extraction mechanism 2 or the air extraction mechanism 3 is controlled to communicate with the extraction channel 11.

Specifically, the air extraction mechanism 3 is an air extraction pump. The wine extraction mechanism 2 includes a wine extraction pump 21, a wine nozzle 22 and a wine extraction pipe 23. One end of the wine nozzle 22 is connected with the housing 1, and the other end of the wine nozzle 22 protrudes from the housing 1. The wine extraction pump 21 is arranged in the housing 1. The wine extraction pipe 23 is detachably connected with the bottom of the housing 1. The wine extraction pump 21, the wine extraction pipe 23 and the wine nozzle 22 are all in communication with the extraction channel 11. Further, the wine extraction pump 21 is provided with a wine pump inlet 211 and a wine pump outlet 212. The red wine enters the wine pump inlet 211 from the wine extraction pipe 23, then passes through the wine pump outlet 212, and flows out from the wine nozzle 22. An end of the wine nozzle 22 away from the housing 1 is obliquely arranged downwards. Preferably, the wine extraction pipe 23 is a retractable structure. In the wine extraction mode, a consumer inserts the wine extraction pipe 23, inserts the housing 1 into the wine bottle 8 and presses the extraction switch 4, the wine extraction pump 21 operates, and the red wine in the wine bottle 8 is extracted out through the wine nozzle 22 via the wine extraction pipe 23. The wine extraction pipe 23 is detachably connected with the bottom of the housing 1 to facilitate the separation of the wine extraction pipe 23 from the housing 1, so that when the wine extraction mode is switched to the air extraction mode, a vacuumizing function of the wine bottle 8 can be achieved. The wine extraction pipe 23 having the retractable structure can expand the scope of application of the extraction device of the present disclosure. Especially, for wine bottles 8 of different depths, the length of the wine extraction pipe 23 can be adaptively adjusted to achieve the wine extraction function. Specifically, the wine extraction pipe 23 at least includes a first section and a second section which are nested with each other. By inserting the first section into the second section, the overall length of the wine extraction pipe 23 can be shortened. By pulling out the first section from the second section and fixing the first section at the connected end, the length of the wine extraction pipe 23 is the sum of the length of the first section and the length of the second section, thereby greatly expanding the length of the wine extraction pipe 23. Within the cognitive scope of those skilled in the art, the wine extraction pipe 23 can also have more nested section structures for sequential nesting. According to the length of the wine bottle 8, the wine extraction pipe 23 is extended or shortened to adapt to the length of the wine bottle 8, thereby facilitating wine extraction.

Moreover, the switching mechanism 5 includes a support frame 51, a passive trigger part 53 and an active trigger part 52. The passive trigger part 53 is arranged at the bottom of the housing 1 and is electrically connected with the controller 7. The active trigger part 52 is arranged on the support frame 51. One end of the support frame 51 is detachably connected with the housing 1, and the other end of the support frame 51 is detachably connected with the wine plug 6. When the support frame 51 is connected with the housing 1, the active trigger part 52 can trigger the passive trigger part 53 to send a signal. The support frame 51 is configured to mount the active trigger part 52, and enables the switching mechanism 5 to be detachably connected with the housing 1 or the wine plug 6 conveniently. The active trigger part 52 performs active triggering to enable the passive trigger part 53 to receive a triggering signal so as to transmit the signal to the controller 7, so that the controller 7 achieves the switching between the wine extraction mode and the air extraction mode.

As an improved solution of this embodiment, the active trigger part 52 is a magnet 521, and the passive trigger part 53 is a Hall sensor 531. The magnet 521 can touch the Hall sensor 531 and trigger the Hall sensor 531 to send a signal to the controller 7 to perform switching between modes.

Further, the wine plug 6 includes a plug sleeve 61 and a plug body 62. An air duct 63 is arranged in the plug sleeve 61, and the plug sleeve 61 is detachably connected with the bottom of the switching mechanism 5. The plug body 62 is movably arranged in the plug sleeve 61 and can open the air duct 63 to communicate the air duct 63 with the extraction channel 11 or close the air duct 63. The inside of the plug sleeve 61 cooperates with the plug body 62, so that the opening or closing of the air duct 63 can be controlled according to different positions of the plug body 62 in the plug sleeve 61. The outside of the plug sleeve 61 is configured to cooperate with the wine bottle 8 to achieve the sealing between an outer wall of the plug sleeve 61 and an inner wall of an opening of the wine bottle 8. Preferably, a circumferential outer wall of the plug sleeve 61 is provided with a plurality of protrusions 64. By the arrangement of the protrusions 64, the friction force between the plug sleeve 61 and the bottle opening of the wine bottle 8 can be increased, and the sealing effect of the wine plug 6 can be improved.

As an improved solution of this embodiment, the wine extraction pump 21 is a suction pump. When the wine extraction pump 21 adopts the suction pump, the red wine in the wine bottle 8 can be extracted out through the principle of suction.

### Embodiment 2

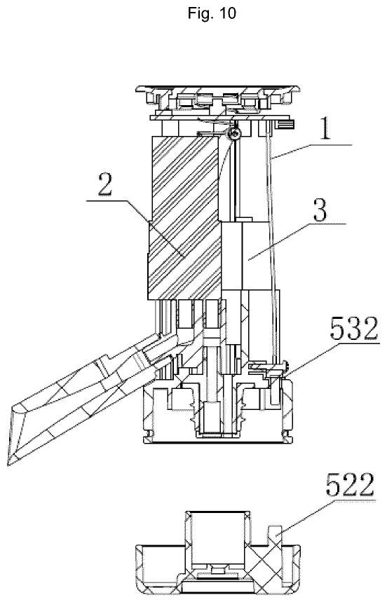

FIG. 10 shows an air extraction and wine extraction two-in-one extraction device according to Embodiment 2 of the present disclosure. This embodiment is similar to Embodiment 1, and the differences are as follows: the active trigger part 52 is a convex pillar 522, and the passive trigger part 53 is a trigger switch 532. The convex pillar 522 is configured to touch the trigger switch 532 to transmit a mode switching signal to the controller 7, thereby achieving the switching between the wine extraction mode and the air extraction mode.

### Embodiment 3

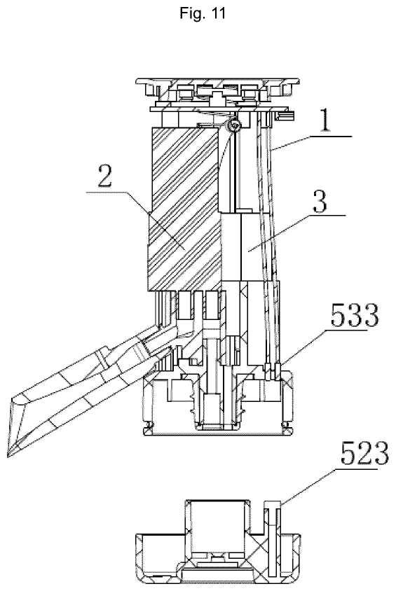

FIG. 11 shows an air extraction and wine extraction two-in-one extraction device according to Embodiment 3 of the present disclosure. This embodiment is similar to Embodiment 1, and the differences are as follows: the active trigger part 52 is a pin 523, and the passive trigger part 53 is a conductive pin 533. The pin 523 touches the conductive pin 533 to generate and transmit a mode switching signal to the controller 7, thereby achieving the switching between the wine extraction mode and the air extraction mode.

### Embodiment 4

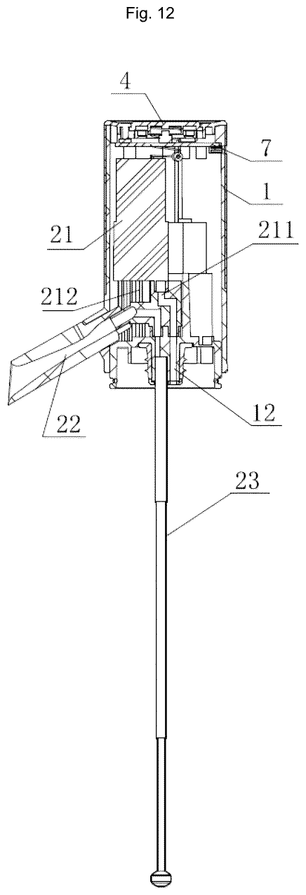

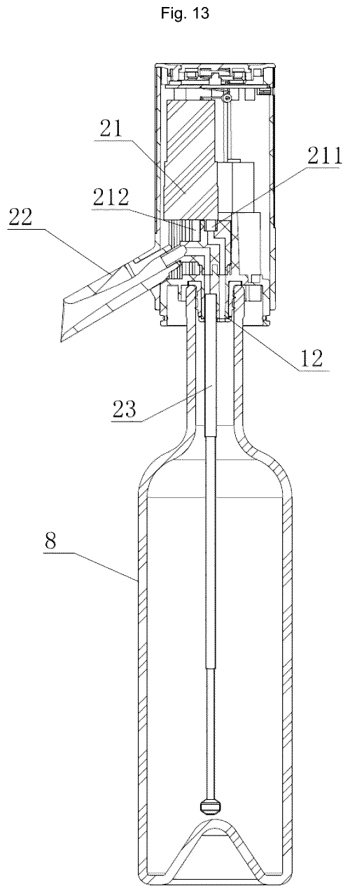

FIG. 12 and FIG. 13 show an air extraction and wine extraction two-in-one extraction device according to Embodiment 4. This embodiment is similar to Embodiment 1, and the difference is as follows: the wine extraction pump 21 is an air injection pump. In this embodiment, an air inlet 12 needs to be additionally provided at the bottom of the housing 1 to achieve an air injection function. When the wine extraction pump 21 adopts the air injection pump, the red wine can be pressed into the wine extraction pipe 23 by injecting air into the wine bottle 8, and then flows out from the wine nozzle 22.

Obviously, the above embodiments of the present disclosure are only examples for clearly illustrating the present disclosure, and are not intended to limit the implementations of the present disclosure. For those of ordinary skill in the art, other different forms of changes or modifications can also be made on the basis of the above illustration. It is not necessary and impossible to exhaustively list all implementations here. Any modifications, equivalent substitutions, improvements, and the like made within the spirit and principle of the present disclosure shall be included within the scope of protection of the claims of the present disclosure.

1. An air extraction and wine extraction two-in-one extraction device, comprising a housing, a wine extraction mechanism, an air extraction mechanism, an extraction switch, a switching mechanism, a wine plug and a controller, wherein the wine extraction mechanism, the air extraction mechanism and the controller are all arranged in the housing; the extraction switch is also arranged on the housing and partially exposed from the housing; the switching mechanism is detachably arranged at a bottom of the housing; an extraction channel is arranged in the housing;
the wine plug is arranged at a bottom of the switching mechanism; the wine extraction mechanism, the air extraction mechanism and the wine plug are all in communication with the extraction channel; the wine extraction mechanism, the air extraction mechanism, the switching mechanism and the extraction switch are all electrically connected with the controller; when the switching mechanism and the wine plug are not mounted, the extraction device is in a wine extraction mode by default; and when the switching mechanism and the wine plug are mounted, the extraction device is switched to an air extraction mode.

2. The air extraction and wine extraction two-in-one extraction device according to claim 1, wherein the wine extraction mechanism comprises a wine extraction pump, a wine nozzle and a wine extraction pipe; one end of the wine nozzle is connected with the housing, and the other end of the wine nozzle protrudes from the housing; the wine extraction pump is arranged in the housing; the wine extraction pipe is detachably connected with the bottom of the housing; and the wine extraction pump, the wine extraction pipe and the wine nozzle are all in communication with the extraction channel.

3. The air extraction and wine extraction two-in-one extraction device according to claim 2, wherein an end of the wine nozzle away from the housing is obliquely arranged downwards.

4. The air extraction and wine extraction two-in-one extraction device according to claim 2, wherein the wine extraction pipe is a retractable structure.

5. The air extraction and wine extraction two-in-one extraction device according to claim 1, wherein the air extraction mechanism is an air extraction pump.

6. The air extraction and wine extraction two-in-one extraction device according to claim 1, wherein the switching mechanism comprises a support frame, a passive trigger part and an active trigger part; the passive trigger part is arranged at the bottom of the housing and is electrically connected with the controller; the active trigger part is arranged on the support frame; one end of the support frame is detachably connected with the housing, and the other end of the support frame is detachably connected with the wine plug; and when the support frame is connected with the housing, the active trigger part can trigger the passive trigger part to send a signal.

7. The air extraction and wine extraction two-in-one extraction device according to claim 6, wherein the active trigger part is a magnet, and the passive trigger part is a Hall sensor; or the active trigger part is a convex pillar, and the passive trigger part is a trigger switch; or the active trigger part is a pin, and the passive trigger part is a conductive pin.

8. The air extraction and wine extraction two-in-one extraction device according to claim 1, wherein the wine plug comprises a plug sleeve and a plug body (62); an air duct is arranged in the plug sleeve, and the plug sleeve is detachably connected with the bottom of the switching mechanism; and the plug body (62) is movably arranged in the plug sleeve and can open the air duct to communicate the air duct with the extraction channel or close the air duct.

9. The air extraction and wine extraction two-in-one extraction device according to claim 8, wherein a circumferential outer wall of the plug sleeve is provided with a plurality of protrusions.

10. The air extraction and wine extraction two-in-one extraction device according to claim 2, wherein the wine extraction pump is a suction pump or an air injection pump.

11. The air extraction and wine extraction two-in-one extraction device according to claim 6, wherein the wine extraction mechanism comprises a wine extraction pump, a wine nozzle and a wine extraction pipe; one end of the wine nozzle is connected with the housing, and the other end of the wine nozzle protrudes from the housing; the wine extraction pump is arranged in the housing; the wine extraction pipe is detachably connected with the bottom of the housing; and the wine extraction pump, the wine extraction pipe and the wine nozzle are all in communication with the extraction channel.

12. The air extraction and wine extraction two-in-one extraction device according to claim 11, wherein an end of the wine nozzle away from the housing is obliquely arranged downwards.

13. The air extraction and wine extraction two-in-one extraction device according to claim 11, wherein the wine extraction pipe is a retractable structure.

14. The air extraction and wine extraction two-in-one extraction device according to claim 6, wherein the air extraction mechanism is an air extraction pump.
